(19) United States
(12) Patent Application Publication
(10) Pub. No.: US 2016/0284503 A1
(43) Pub. Date: Sep. 29, 2016

(54) X-RAY TUBE

(71) Applicants: KABUSHIKI KAISHA TOSHIBA, Minato-ku (JP); Toshiba Electron Tubes & Devices Co., Ltd., Otawara-shi (JP)

(72) Inventors: Miki WATANABE, Sakura (JP); Hidero Anno, Otawara (JP); Tomonari Ishihara, Otawara (JP)

(73) Assignees: KABUSHIKI KAISHA TOSHIBA, Minato-ku (JP); Toshiba Electron Tubes & Devices Co., Ltd., Otawara-shi (JP)

(21) Appl. No.: 15/081,098

(22) Filed: Mar. 25, 2016

(30) Foreign Application Priority Data
Mar. 27, 2015 (JP) 2015-066429

(51) Int. Cl. H01J 35/06

(52) U.S. Cl. CPC H01J 35/06; H01J 2235/06

(57) ABSTRACT

According to one embodiment, an X-ray tube includes an envelope, an anode and a cathode structure. The anode and the cathode structure are provided opposite to each other in the envelope. The cathode structure includes a cathode and an insulator which supports the cathode and is attached to the envelope. The insulator includes a basal portion attached to the envelope, a support portion which supports the cathode at a distal end projecting from the basal portion, and a tubular projection portion which is provided to project from the basal portion and opposite to a periphery of the support portion.

### CROSS-REFERENCE TO RELATED APPLICATIONS

This application is based upon and claims the benefit of priority from Japanese Patent Application No. 2015-066429, filed Mar. 27, 2015, the entire contents of which are incorporated herein by reference.

### FIELD

Embodiments described herein relate generally to an X-ray tube.

### BACKGROUND

Conventionally, X-ray tubes are applied for many purposes. For example, they are applied to medical diagnostic equipment. In the X-ray tubes, an anode and a cathode are provided in an envelope, and electrons radiated from the cathode collide with the anode, thereby producing X-rays. In an anode grounded X-ray tube, a cathode is supported by an insulator, for example, ceramic, in the envelope.

When an X-ray tube is in use, if an electron avalanche occurs at the insulator, a through discharge occurs at the insulator, causing a failure of the X-ray tube.

The electron avalanche at the insulator is a phenomenon in which electrons are emitted from a cathode because of a localized high electric field (field emission), the emitted electrons fly toward a positive side (a high-potential side) in accordance with an electric field, and then collide with part of the insulator, as a result of which secondary electrons are radiated from the part of the insulator, the number of secondary electrons generated at a surface of the insulator exponentially increases, and the insulator becomes positively charged, and thus the emitted electrons increase their number and concentrately collide with single part of the insulator. It is known that such an electron avalanche occurs when the secondary electron emission coefficient of an insulator such as alumina is 1 or higher.

In such a manner, if electrons collides with single part of the insulator, heat accumulates at the part of the insulator, the part of the insulator is deformed, and discharge between the insulator and the cathode causes a through discharge at the insulator. If a through discharge occurs in the insulator, it causes a failure of the X-ray tube, such as a vacuum leak.

### BRIEF DESCRIPTION OF THE DRAWINGS

FIG. 1 is a cross-sectional view of a cathode structure of an X-ray tube according to an embodiment.

FIG. 2 is a cross-sectional view of an X-ray tube assembly including the X-ray tube.

FIG. 3 is a graph showing an electric potential distribution near to the surface of an insulator in the X-ray tube. The electric potential distribution is obtained in the case where the potential of an envelope is ground potential and that of a cathode is −120 kV.

FIG. 4 is a cross-sectional view of a cathode structure in an X-ray tube of a comparative example.

FIG. 5 is a cross-sectional view of an X-ray tube assembly including the X-ray tube of the comparative example.

FIG. 6 is a graph showing an electric potential distribution near to the surface of an insulator in the X-ray tube of the comparative example. The electric potential distribution is obtained in the case where the potential of an envelope is ground potential and that of a cathode is −120 kV.

FIG. 7A is an explanatory view for explaining the insulator in the X-ray tube of the comparative example with respect to the difference between the shape of the insulator in the X-ray tube according to the embodiment and that of the insulator in the X-ray tube of the comparative example.

FIG. 7B is an explanatory view for explaining the insulator in the X-ray tube according to the embodiment with respect to the difference between the shape of the insulator in the X-ray tube according to the embodiment and that of the insulator in the X-ray tube of the comparative example.

FIG. 8A is an explanatory view for explaining the insulator in the X-ray tube of the comparative example with respect to the difference between how a through discharge easily occurs in the insulator of the X-ray tube according to the embodiment and that in the insulator of the X-ray tube of the comparative example.

FIG. 8B is an explanatory view for explaining the insulator in the X-ray tube in the embodiment with respect to the difference between how a through discharge easily occurs in the insulator of the X-ray tube according to the embodiment and that in the insulator of the X-ray tube of the comparative example.

### DETAILED DESCRIPTION

In general, according to one embodiment, there is provided an X-ray tube comprising: an envelope; and an anode and a cathode structure which are provided opposite to each other in the envelope. The cathode structure includes a cathode and an insulator which supports the cathode and is attached to the envelope. The insulator includes a basal portion attached to the envelope, a support portion which supports the cathode at a distal end projecting from the basal portion, and a tubular projection portion which is provided to project from the basal portion and opposite to a periphery of the support portion.

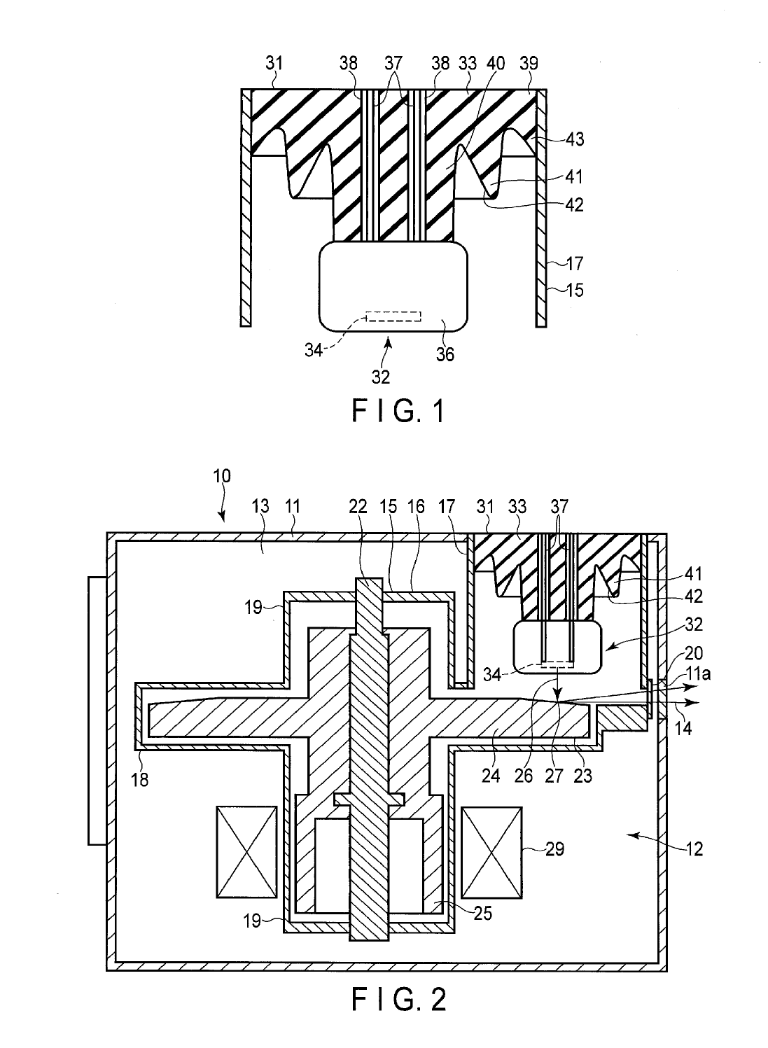

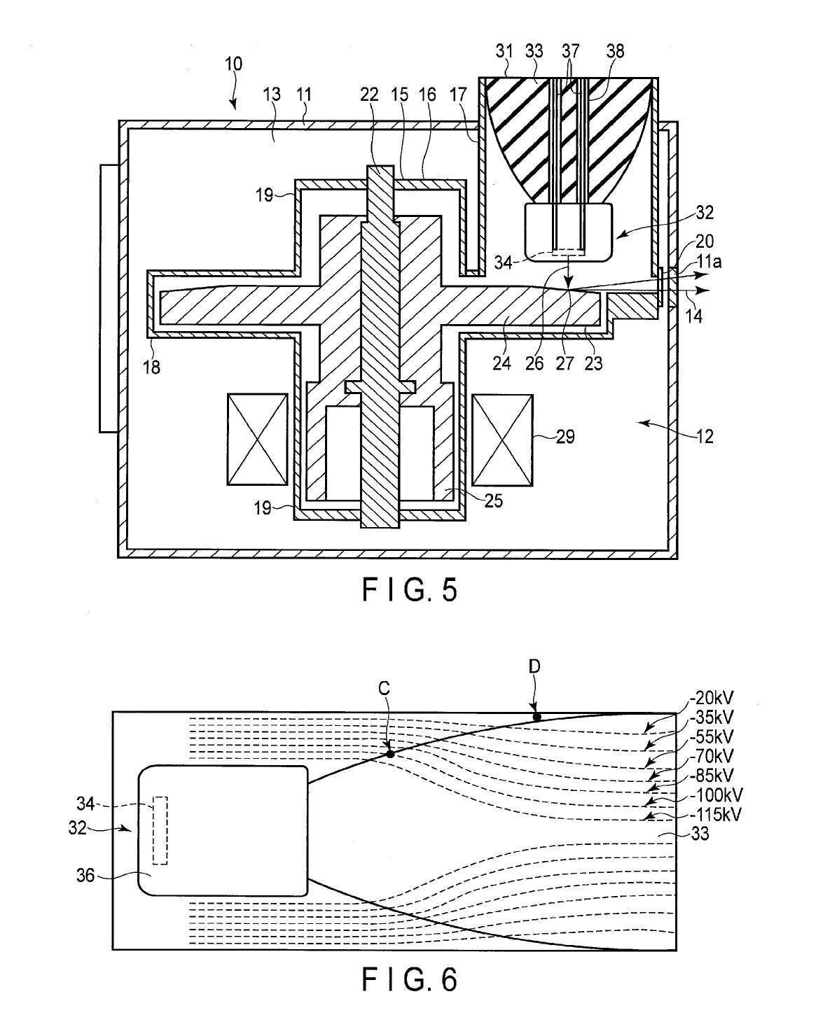

Embodiments will be explained with reference to FIGS. 1 to 8B.

FIG. 2 shows an X-ray tube assembly 10. The X-ray tube assembly 10 comprises a housing 11 and an X-ray tube 12 provided in the housing 11. The X-ray tube 12 is an anode grounded X-ray tube, and also a rotation anode X-ray tube. The anode potential is ground potential. The space between the housing 11 and the X-ray tube 12 is filled with coolant 13 such as insulating oil or an aquatic coolant containing antifreeze, for example, a glycol solution. Although it is not shown, a cooling apparatus is connected to the housing 11 by hoses. The coolant 13 in the housing 11 is circulated and cooled by the cooling apparatus.

In the housing 11, an X-ray transmission window lie is provided, and permits X-rays 14 emitted from the X-ray tube 12 to pass through the X-ray transmission window 11a.

The X-ray tube 12 comprises an envelope 15 which is held vacuum. In the envelope 15, an anode envelope portion 16 and a cathode envelope portion 17 are formed. The anode envelope portion 16 is formed in the shape of a cylinder including a large-diameter portion 18 and small-diameter portions 19 which are provided upward and downward of the large-diameter portion 18, respectively. The cathode envelope portion 17 is cylindrically formed and provided upward of the large-diameter portion 18 such that the large-diameter portion 18 communicates with the cathode envelope portion 17. To an outer surface of part of the large-diameter portion 18 of the anode envelope portion 16, an X-ray transmission window 20 is attached. The X-ray transmission window 20 is located opposite to the X-ray transmission window 11a of the housing 11, and permits X-rays 14 to pass through the X-ray transmission window 20. In the anode envelope portion 16, a fixed shaft 22 is provided at the center of the anode envelope portion 16, and a rotary anode 23 is provided as an anode supported in such a way as to be rotatable around the fixed shaft 22. The fixed shaft 22 is provided as an axis of rotation around which the rotary anode 23 is to be rotated.

In the rotary anode 23, a disc portion 24 and a rotor portion 25 are formed; and the disc portion 24 is rotatably provided in the large-diameter portion 18, and the rotor portion 25 is rotatably provided in the lower one of the small-diameter portions 19. An outer peripheral portion of an upper surface of the disc portion 24 of the rotary anode 23 is inclined downward by a predetermined angle to face the X-ray transmission window 20. At this inclined outer peripheral portion, an anode target 27 is provided which produces X-rays 14 when electrons 26 collide with the anode target 27.

Around the lower small-diameter portion 19 of the anode envelope portion 16, a coil 29 is provided which produces a driving magnetic field to rotate the rotor portion 25, thereby rotating the rotary anode 23 and the anode target 27.

Furthermore, in the envelope 15 (the cathode envelope portion 17), a cathode structure 31 is provided opposite to the anode target 27. The cathode structure 31 comprises a cathode 32 and an insulator 33 which supports the cathode 32 and is attached the envelope 15 (the cathode envelope portion 17).

The cathode 32 comprises: a filament 34 serving as an electron source which produces electrons 26; and a cathode cup 36 which converges electrons 26 generated from the filament 34. High-voltage cables 37 are electrically connected to the cathode 32 through through holes 38 formed in the insulator 33, the high-voltage cables 37 being provided to connect the cathode 32 and a high-voltage supply which applies a high voltage to the cathode 32, and also supplies current thereto.

As shown in FIG. 1, the insulator 33 is formed of insulating material such as ceramic. The insulator 33 includes a basal portion 39 attached to the envelope 15 (the cathode envelope portion 17), a cylindrical support portion 40 projecting from a surface of the basal portion 39 to support the cathode 32 at a distal end of the support portion 40, and a tubular projection portion 41 located to project from the surface of the basal portion 39 and opposite to the cathode 32 and a periphery of the support portion 40. On an inner peripheral side of the projection portion 41, which is located opposite to the cathode 32 and the periphery of the support portion 40, an opposite surface 42 is formed such that the distance between the opposite surface 42 and the periphery of the support portion 40 gradually increases from a proximal end side of the projection portion 41 to a distal end side of the projection portion 41 in the projecting direction thereof.

It should be noted that in the embodiment, an outer projection portion 43 is provided outward of the projection portion 41 to project from the basal portion 39; however, the outer projection portion 43 has not always need to be provided.

Furthermore, in the X-ray tube 12, the rotary anode 23 is rotated, and a voltage is applied between the rotary anode 23 and the cathode 32, whereby electrons 26 are radiated from the filament 34 of the cathode 32, and collide with the anode target 27 to produce X-rays 14, and the produced X-rays 14 are radiated to the outside of the housing 11 through the

X-ray transmission window 20 of the envelope 15 and the X-ray transmission window 11a of the housing 11.

FIG. 4 shows a cathode structure 31 of a comparative example. In the following explanation of the cathode structure 31 of the comparative example, elements of the cathode structure 31 which are identical to those in the embodiment will be denoted by the same reference numbers as in the elements of the embodiment, respectively. In the cathode structure 31 of the comparative example, an insulator 33 is conically formed, and a cathode 32 is supported at a top portion of the cathode structure 31 which is a distal end of the insulator 33.

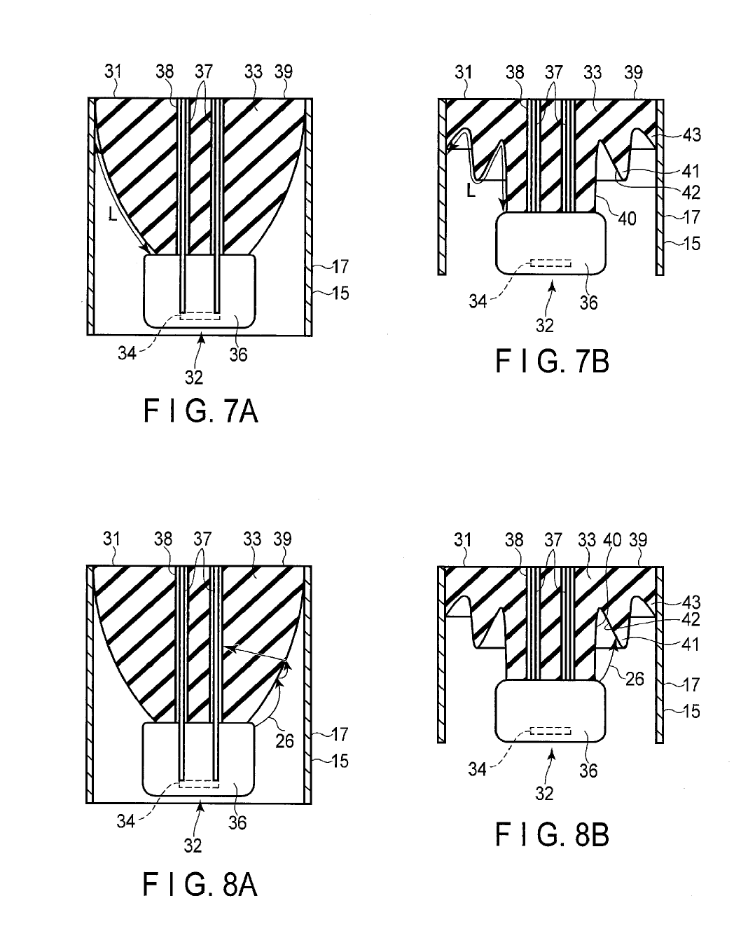

The shape of the insulator 33 of the cathode structure 31 according to the embodiment as shown in FIG. 1 and that of the insulator 33 of the cathode structure 31 of the comparative example as shown in FIG. 4 will be explained while being compared with each other with reference to FIGS. 7A and 7B.

In the comparative example, in order to ensure a creepage distance L at the surface of the insulator 33 between the cathode 32, which is at a low potential and the envelope 15, which is at ground potential, the insulator 33 is set long in the axial direction of the insulator 33.

By contrast, in the cathode structure 31 in the embodiment, the projection portion 41 projects from the surface of the insulator 33. It is therefore possible to ensure the creepage distance L at the surface of the insulator 33 between the cathode 32, which is at a low potential, and the vacuum envelope 15, which is at ground potential, and at the same time, shorten the insulator 33 in the axial direction thereof, thus making the cathode structure 31 smaller. As a result, the X-ray tube 12 and the X-ray tube assembly 10 can also be made smaller.

Next, with reference to FIGS. 8A and 8B, it will be explained how a through discharge more easily occurs in the insulator 33 of the cathode structure 31 of the comparative example as shown in FIG. 4, than in the insulator 33 of the cathode structure 31 according to the embodiment as shown in FIG. 1, while comparing the embodiment and the comparative example with each other.

In the cathode structure 31 of the comparative example shown in FIG. 4, electrons 26 emitted from the cathode 32 include electrons which travel toward the insulator 33 in accordance with an electric field as shown in FIG. 6. When the electrons 26 traveling toward the insulator 33 collide with part of the insulator 33, secondary electrons are radiated from the part of the insulator 33, the number of radiated secondary electrons exponentially increases, and the insulator 33 becomes positively charged. As a result, an electron avalanche easily occurs in which electrons 26 concentratedly collide with single part of the insulator 33. This is because a potential gradient along the surface of the insulator 33 (potential gradient between C and D as shown in FIG. 6) is great. In such a manner, when electrons 26 collide with single part of the insulator 33, heat accumulates at the part of the insulator 33, the part of the insulator 33 is deformed, and discharge between the insulator 33 and the cathode 32 causes a through discharge at the insulator 33. Then, if a through discharge occurs in the through hole 38 of the insulator 33, it causes a failure of the X-ray tube 12, such as a vacuum leak. Tt should be noted that in order to explain the above electric field, in FIG. 6, equipotential lines of −20 kV, −35 kV, −55 kV, −70 kV, −85 kV, −100 kV and −115 kV are shown by dashed lines.

By contrast, in the cathode structure 31 according to the embodiment as shown in FIG. 1, there is a potential gradient from the cathode 32 at a low potential and the distal end side of the support portion 40 supporting the cathode 32, to part of the envelope 15 which surrounds the cathode 32 and the distal end side of the support portion 40 and is at ground potential; that is, there is a gradient from the low potential to ground potential. In view of this point, as shown in FIGS. 1 to 3, the opposite surface 42 of the projection portion 41 is provided opposite to the cathode 32 and the distal end side of the support portion 40 in such a manner as to cross the above potential gradient from the low potential to ground potential, i.e., in such a manner as to extend along equipotential lines. Thus, a potential gradient in the opposite surface 42 in the projection portion 41 is small.

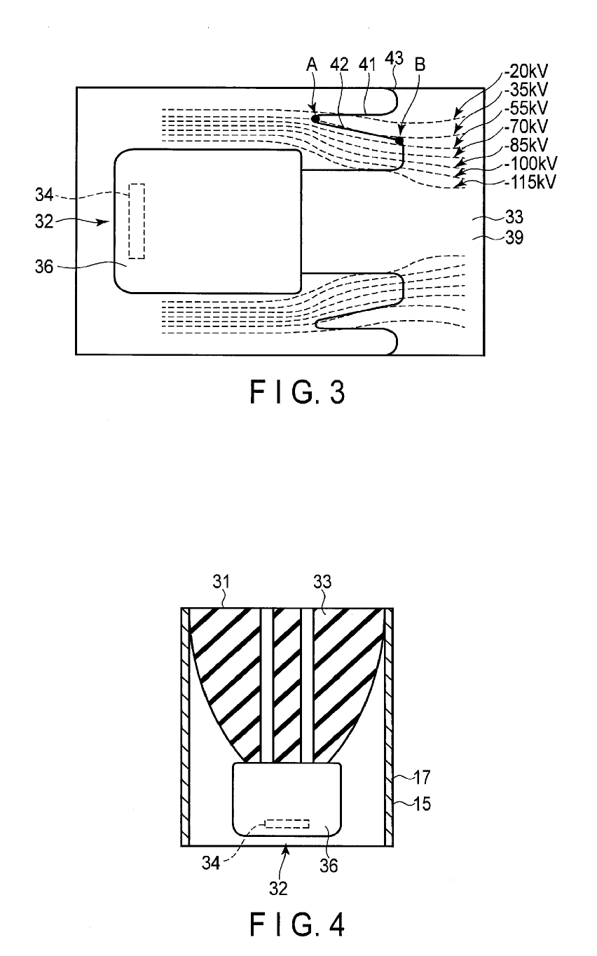

FIG. 3 shows the result of analysis of potential distribution in the opposite surface 42 of the projection portion 41, and A and B in FIG. 3 indicate the distal end side and proximal end side of the opposite surface 42 of the projection portion 41, respectively. It should be noted that in FIG. 3 also, equipotential lines of −20 kV, −35 kV, −55 kV, −70 kV, −85 kV, −100 kV and −115 kV are shown by dashed lines. As can be seen from FIG. 3, the potential gradient between A and B in the opposite surface 42 of the projection portion 41 extends along an equipotential line, and is small and gentle. Where the potential of the cathode 32 is −120 kV, the potential difference in the opposite surface 42 falls within the range of 5 kV.

Also, where the potential gradient in the opposite surface 42 of the projection portion 41 is small and gentle, electrons 26 easily disperse when colliding with the insulator 33; that is, the possibility of the electrons 26 concentrately colliding with single part of the insulator 33 is reduced.

Also, the possibility of the electrons 26 concentrately colliding with single part of the insulator 33 is reduced by providing the opposite surface 42 of the projection portion 41, whose potential gradient is small and gentle, in an orbit in which a larger number of electrons 26 easily travel from the cathode 32 to the insulator 33 in accordance with an electric field.

As described above, in the X-ray tube 12 according to the embodiment, the cathode structure 31 can be made smaller; and it is also possible to restrict a through discharge at the insulator 33, since the insulator 33 includes the projection portion 41, which is cylindrically formed to project from the basal portion 39 and located opposite to the cathode 32 and the periphery of the support portion 40.

Furthermore, in the inner peripheral surface of the projection portion 41, which is located opposite to the cathode 32 and the periphery of the support portion 40, the opposite surface 42 is formed such that the distance between the opposite surface 42 and the periphery of the support portion 40 gradually increases from the proximal end side of the projection portion 41 to the distal end side of the projection portion 41 in the projection direction thereof; that is, the potential gradient in the opposite surface 42 in the projection portion 41 can be made small and gentle.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray tube comprising:
an envelope; and
an anode and a cathode structure which are provided opposite to each other in the envelope,
wherein the cathode structure includes a cathode and an insulator which supports the cathode and is attached to the envelope, and
the insulator includes a basal portion attached to the envelope, a support portion which supports the cathode at a distal end projecting from the basal portion, and a tubular projection portion which is provided to project from the basal portion and opposite to a periphery of the support portion.

2. The X-ray tube of claim 1, wherein the projection portion of the insulator includes an opposite surface which is formed such that a distance between the opposite surface and a periphery of the support portion gradually increases from a proximal end side of the projection portion to a distal end side of the projection portion in a projection direction thereof.
